(19) United States
(12) Patent Application Publication
(10) Pub. No.: US 2010/0302343 A1
(43) Pub. Date: Dec. 2, 2010

(54) VIDEOCONFERENCING TERMINAL AND METHOD OF OPERATION THEREOF TO MAINTAIN EYE CONTACT

(75) Inventor: Cristian A. Bolle, Bridgewater, NJ (US)

Correspondence Address: HITT GAINES, PC;ALCATEL-LUCENT, PO BOX 832570, RICHARDSON, TX, 75083, US

(73) Assignee: Alcatel-Lucent USA, Incorporated, Murray Hill, NJ (US)

(21) Appl. No.: 12/472,250

(22) Filed: May 26, 2009

(51) Int. Cl. H04N 7/14

(52) U.S. Cl. 348/14.08; 348/14.16; 348/E07.078

(57) ABSTRACT

The disclosure provides apparatuses for videoconferencing and a method of operation thereof. In one embodiment, the apparatus includes: (1) a flat panel display including a substrate and a first two-dimensional array of electronic light sources fabricated along the substrate such that a second two-dimensional array of substantially transparent regions of the substrate are laterally interspersed among the electronic light sources, the display being able to transmit externally received light through the substantially transparent regions and (2) a camera configured to receive light external to the display through the substantially transparent regions of the second two-dimensional array.

### CROSS REFERENCE TO RELATED DISCLOSURE

This application is related to co-pending U.S. patent application Ser. No. 12/238,096, filed by Cristian A. Bolle on Sep. 25, 2008, entitled “Videoconferencing Terminal and Method of Operation Thereof to Maintain Eye Contact” and incorporated herein by reference in its entirety.

### TECHNICAL FIELD

The disclosure is directed, in general, to videoconferencing terminals.

### BACKGROUND DESCRIPTION

This section introduces aspects that may be helpful in facilitating a better understanding of the disclosure. Accordingly, the statements of this section are to be read in this light and are not to be understood as admissions about what is in the prior art or what is not in the prior art.

Communication via computer networks frequently involves far more than transmitting text. Computer networks, such as the Internet, can also be used for audio communication and visual communication. Still images and video are examples of visual data that may be transmitted over such networks.

One or more cameras may be coupled to a personal computer (PC) to provide visual communication. The camera or cameras can then be used to transmit real-time visual information, such as video, over a computer network. Dual transmission can be used to allow audio transmission with the video information. Whether in one-to-one communication sessions or through videoconferencing with multiple participants, participants can communicate via audio and video in real time over a computer network (i.e., voice-video communication). The visual images transmitted during voice-video communication sessions depend on the placement of the camera or cameras.

### SUMMARY

Some embodiments provide for voice-video communications in which a participant can maintain eye contact. In these embodiments, the camera(s) and viewing screen are located together to reduce or eliminate a location disparity that could otherwise cause the participant to not look into the camera while watching the received video.

In one aspect, the disclosure provides an apparatus. In one embodiment, the apparatus includes: (1) a flat panel display including a substrate and a first two-dimensional array of electronic light sources fabricated along the substrate such that a second two-dimensional array of substantially transparent regions of the substrate are laterally interspersed among the electronic light sources, the display being able to transmit externally received light through the substantially transparent regions and (2) a camera configured to receive light external to the display through the substantially transparent regions of the second two-dimensional array.

Another aspect of the disclosure provides a method of videoconferencing. In one embodiment, the method includes: (1) receiving light from an object and into a camera, the light received substantially through substantially transparent regions of a flat panel display that are interspersed among electronic light sources of the flat panel display and (2) producing image data from the received light, the image data being usable to reproduce a two-dimensional image of the object on a screen.

Yet another aspect of the disclosure provides another apparatus. In one embodiment, the apparatus includes a first videoconferencing terminal connectable to support a videoconferencing session video with a second videoconferencing terminal via a telecommunications network, wherein the first terminal includes: (1A) a flat panel display having electronic light sources fabricated over a substrate such that substantially transparent regions of the substrate are interspersed between the electronic light sources and are capable of transmitting external light through the display and (1B) a camera configured to receive the external light through the display via the substantially transparent regions.

### BRIEF DESCRIPTION

Reference is now made to the following descriptions of embodiments, provided as examples only, taken in conjunction with the accompanying drawings, in which:

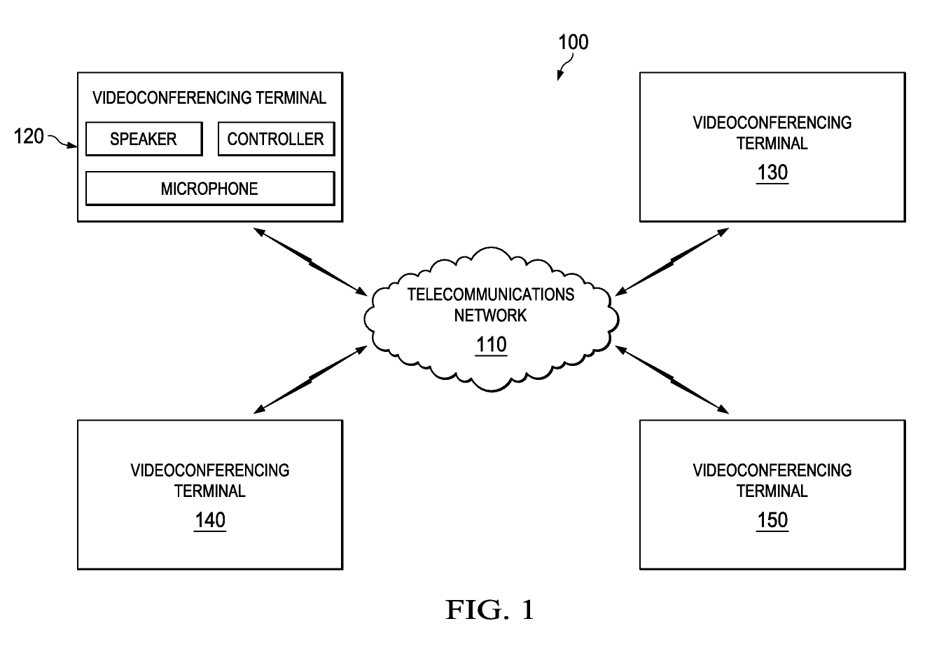

FIG. 1 is a schematic block diagram of an embodiment of a videoconferencing infrastructure within which a videoconferencing terminal constructed according to the principles of the disclosure may operate;

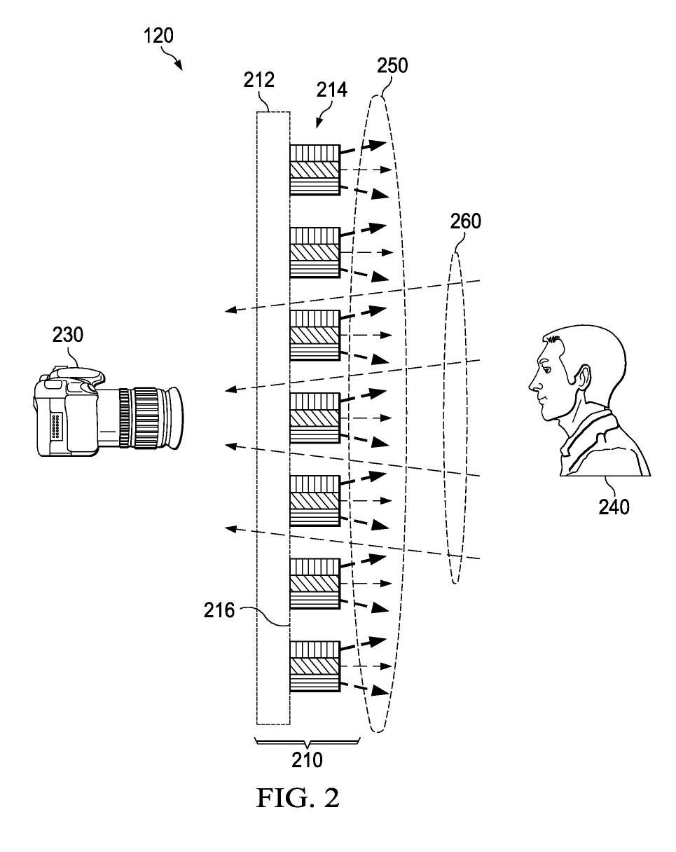

FIG. 2 is a side elevation view of an embodiment of a videoconferencing terminal, e.g., of the videoconferencing infrastructure of FIG. 1, constructed according to the principles of the disclosure; and

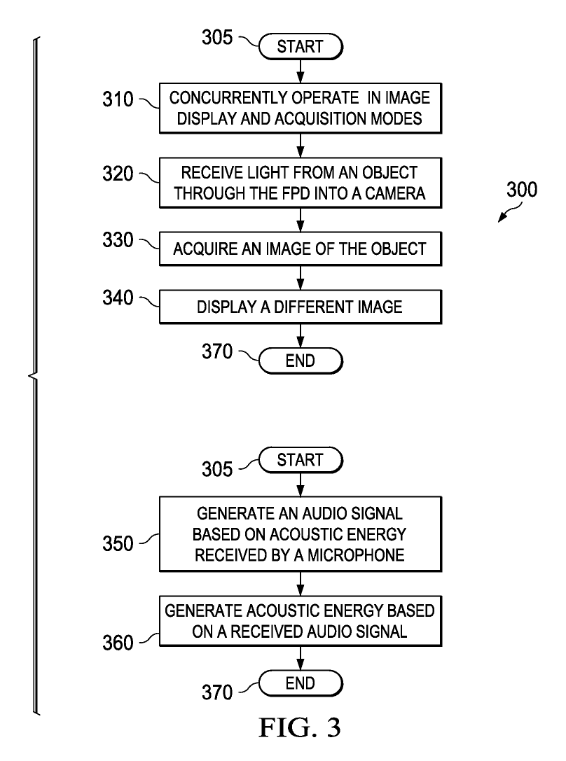

FIG. 3 is a flow diagram of one embodiment of a method of videoconferencing carried out according to the principles of the disclosure.

### DETAILED DESCRIPTION

In a videoconferencing terminal, establishing eye contact between the participants greatly enhances the feeling of intimacy. Unfortunately, the display and camera in many conventional videoconferencing terminals are not aligned. The resulting parallax prevents eye contact from being established between participants of the videoconference.

Some videoconferencing terminals address the eye contact problem by using a large, tilted two way mirror to superimpose the camera position with the center of the display. Regrettably, this approach is bulky, frustrating the modern trend toward flat displays. Other videoconferencing terminals employ digital image-based rendering to recreate a central, eye contact view from multiple side views. One disadvantage of this approach is that it requires multiple cameras, significant image processing power and often yields unsuitable results.

Disclosed herein are embodiments of a videoconferencing terminal in which the camera is placed behind or within a modified FPD, such as a light-emitting-diode (LED) display such that the camera looks through the display at an object to be imaged (e.g., a participant in a videoconference). The modified FPD is fabricated on a planar substrate such as a substantially transparent substrate. The substantially transparent substrate, for example may be glass. In other embodiments, the substantially transparent substrate may be another substrate that is transparent to visible light or is transparent to one or more frequency segments of the visible light spectrum. The pixels in the modified FPD are a combination of substantially transparent regions and light emitting areas that include electronic light sources. The modified FPD includes the necessary addressing electronics for the electronic light sources. An array of the electronic light sources can be embedded in an active layer of electronics and pixel addressing logic used to address the electronic light sources.

The electronic light sources can be either white or color electronic light sources that are used to render an image, such as, an image of a remotely located video-conference participant. The color electronic light sources may be arranged in a cluster of red, green, and blue electronic light sources that are driven together to form a full-color pixel. The substantially transparent regions of the modified FPD are used to capture the image of an object, such as a local video conference participant, through the substantially transparent regions of the modified FPD. The modified FPD with a combination of the substantially transparent regions and the electronic light sources allow the modified FPD to simultaneously display and capture images without the need for synchronization. Digital processing of the captured images may be used to remove undesired diffraction which may be caused by the substantially transparent regions. The camera may include the necessary optical processing to remove diffraction or other artifacts from the captured images. Post-processing of optical images is well known in the art. A filter, such as a spatial light filter may also be used to reduce diffraction. With the benefit of various embodiments of the videoconferencing terminal described herein, it is possible for a videoconferencing participant to experience a feeling of intimacy in the videoconference.

FIG. 1 is a schematic block diagram of one embodiment of a videoconferencing infrastructure 100 within which a videoconferencing terminal constructed according to the principles of the disclosure may operate. This embodiment of the videoconferencing infrastructure 100 is centered about a telecommunications network 110 that is employed to interconnect two or more videoconferencing terminals 120, 130, 140, 150 for communication of video signals or information, and perhaps also audio signals or information, therebetween. An alternative embodiment of the videoconferencing infrastructure 100 is centered about a computer network, such as the Internet. Still another embodiment of the videoconferencing infrastructure 100 involves a direct connection between two videoconferencing terminals, e.g., connection of the videoconferencing terminals 120, 130 via a plain old telephone (POTS) network. As represented in the videoconferencing terminal 120, the videoconferencing terminals 120, 130, 140, 150, may include components typically included in a conventional videoconferencing terminal, such as, a microphone, a speaker and a controller. The microphone can be configured to generate an audio signal based on acoustic energy received thereby, and the speaker can be configured to generate acoustic energy based on an audio signal received thereby.

FIG. 2 is a side elevation view of an embodiment of a videoconferencing terminal, e.g., the videoconferencing terminal 120 of FIG. 1, constructed according to the principles of the disclosure. The videoconferencing terminal 120 is configured to operate in concurrent image display and image acquisition modes. The videoconferencing terminal 120 includes an FPD 210 that may be considered a modified FPD. The videoconferencing terminal 120 also includes a camera 230. Additionally, the videoconferencing terminal 120 may include additional components typically included in a conventional videoconferencing terminal. For example, the videoconferencing terminal 120 may include a microphone, a speaker and a controller that directs the operation of the videoconferencing terminal 120. The microphone may be associated with the controller and the speaker may also be associated with the controller.

The FPD 210 is fabricated on a substantially transparent substrate 212. The substantially transparent substrate 212 may be a conventional transparent substrate that is commonly used in conventional FPDs, such as a conventional liquid crystal display (LCD). For example, the substantially transparent substrate 212 may be an EAGLE^{2000®}, an EAGLE XG™, or another LCD glass manufactured by Corning Incorporated of Corning, N.Y. The substantially transparent substrate 212 may also be an LCD glass manufactured by another company. In the illustrated embodiment, the FPD 210 includes the electronic light sources 214 that are separated by substantially transparent regions 216.

The substantially transparent regions 216 and the electronic light sources 214 of the FPD 210 are interspersed among each other. The electronic light sources 214 may be positioned to present an image to display. The electronic light sources 214 are configured to emit the light needed to render the image for display in accordance with an active backplane, e.g., the substrate 212. In one embodiment, the electronic light sources 214 may be LEDs. In some embodiments, the LEDs may be organic LEDs (OLEDS). In an alternative embodiment, the electronic light sources 214 may be other light-emitting pixels that are used in another conventional or later-developed FPD technology. Since the embodiment of FIG. 2 includes pixels of electronic light sources 214, the FPD 200 does not require a backlight to illuminate pixels of the FPD 200 to display an image. Those skilled in the pertinent art understand the structure and operation of conventional FPDs and the light-emitting pixels that are used to display images.

The active backplane directs the operation of each of the electronic light sources. The active backplane, not illustrated in detail in FIG. 2, may be partially or totally incorporated in the substantially transparent substrate 212. A first area, e.g., a central region, of each pixel on the substantially transparent substrate 212 may include the electronic light sources 214 thereon and one or more other substantially transparent regions 216 of each pixel may be able to transmit image light to the camera 230. In other embodiments, the active backplane for the electronic light sources 214 may be formed on a separate substrate from the substantially transparent substrate 212. The active backplane may include a matrix of thin film transistors (TFT) with each TFT driving and/or controlling a particular one of the electronic light sources 214 of a pixel. The active backplane may operate as a conventional array-type active backplane. In one embodiment, the active backplane may operate similar to an active backplane employed in an LCD display.

The camera 230 is also associated with the FPD 210 and is located on a backside of the FPD 210. Though FIG. 2 only schematically represents the camera 230, the camera 230 may take the form of an array-type charge-coupled device (CCD) solid-state camera equipped with a lens allowing it to capture an image from a focal plane that is beyond the FPD 210. Those skilled in the art will recognize that the camera 230 may be of any conventional or later-developed camera. Those skilled in the pertinent art also understand the structure and operation of such cameras, e. g., a conventional camera used in a videoconferencing terminal. The optical axis of the camera 230 faces (e.g., passes through a center of) the FPD 210. The camera 230 may be located at any distance from the FPD 210. However, in the illustrated embodiment, the camera 230 is located within 12 inches of the FPD 210. In an alternative embodiment, the camera 230 is located within four inches of the FPD 210. The camera 230 is configured to acquire its image substantially through or substantially only through the substantially transparent regions 216 of the pixels. The camera 230 may include circuitry and or software for processing of the captured images to remove undesired diffraction artifacts, e.g., via processing equivalent to optical spatial filtering. Accordingly, the camera 230 may be configured to perform post-processing of the captured images to increase clarity.

An object 240 lies on the frontside of the FPD 210, i.e., the side of the FPD 210 that is opposite the camera 230. In the illustrated embodiment, the object 240 includes a face of a participant in a videoconference. However, the object 240 may be any object whatsoever.

The arrows 250 signify the light emitted by the electronic light sources 214 bearing visual information to provide an image that can be viewed by the object 240. The camera 230 is configured to receive light, represented by the arrows 260, traveling from the object 240 through the FPD 210 and acquire an image of the object 240. As illustrated, the camera 230 receives the light 260 substantially through or substantially only through the substantially transparent regions 216. Although FIG. 2 does not show such, a backside surface of the FPD 210 may be rough or black to scatter or absorb the light such that it does not create a glare in the lens of the camera 230. For the same reasons, surface surrounding the camera 230 may also be black.

FIG. 3 is a flow diagram of one embodiment of a method 300 of videoconferencing carried out according to the principles of the disclosure. The method begins in a start step 305 and includes separate paths for the concurrent processing of video data and of audio data. In a step 310, an image display mode and an image acquisition mode are concurrently entered. In the image display mode, electronic light sources produce the light to form an image on the FPD. The electronic light sources may be fabricated on a substantially transparent substrate. In one embodiment, each electronic light source may include a set of light-emitting-diodes, e.g., for red, green, and blue light.

In the image acquisition mode, light from an object is received through substantially transparent regions interspersed among the electronic light sources. The electronic light sources and the substantially transparent regions may be arranged in a first array and a second array, respectively. In various embodiments, the electronic light sources of the first array are laterally interleaved with the substantially transparent regions of the second array. The electronic light sources may be arranged in a first regular two-dimensional (2D) array of pixels, and the substantially transparent regions may be arranged in a second regular 2D array, wherein each substantially transparent region of the second regular 2D array is a part of a pixel in the first regular 2D array.

Steps that may be performed in the image display mode and the image acquisition mode are now described. In the image acquisition mode, a camera may acquire an image through the FPD. Accordingly, in a step 320, light from an object (such as the viewer) is received through the FPD into the camera. In a step 330, the camera acquires an image of the object. The light from the object may be received substantially through only the transparent regions in the FPD into the camera, and the camera may acquire the image substantially through only the transparent regions in the FPD.

In the image display mode, an image is displayed in a step 340. The image may be a received image from, for example, a videoconferencing terminal that is remote to the FPD. Electronic light sources may produce light to form the different image on the FPD. The acquiring step 330 may be performed, e.g., concurrently with the displaying step 340. The method 300 can then end in a step 370.

Concurrent with the processing of video data, audio data may also be processed. As such, a microphone generates an audio signal based on acoustic energy received thereby in a step 350. The microphone may be coupled to the FPD and the acoustic energy may be associated with the viewer. In a step 360, acoustic energy is generated based on an audio signal received thereby. The audio signal may be received from the same remote videoconferencing terminal that sends the image to display. The method 300 can then end in a step 370.

Those skilled in the art to which the application relates will appreciate that other and further additions, deletions, substitutions and modifications may be made to the described embodiments. Additional embodiments may include other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

What is claimed is:

1. An apparatus, comprising:
a flat panel display including a substrate and a first two-dimensional array of electronic light sources fabricated along said substrate such that a second two-dimensional array of substantially transparent regions of the substrate are laterally interspersed among said electronic light sources, said display being able to transmit externally received light through said substantially transparent regions; and
a camera configured to receive light external to said display through said substantially transparent regions of said second two-dimensional array.

2. The apparatus as recited in claim 1, further comprising electronic circuitry being capable of controlling said electronic light sources to display video images on said display.

3. The apparatus as recited in claim 1, further comprising electronic circuitry capable of operating said camera to acquire an image and substantially concurrently operate said electronic light sources to display another image on said display.

4. The apparatus as recited in claim 1 wherein said electronic light sources are arranged in a first regular two-dimensional array and said substantially transparent regions are arranged in a second regular two-dimensional array.

5. The apparatus as recited in claim 4 wherein said electronic light sources of said first regular two-dimensional array are laterally interleaved with said substantially transparent regions of said second regular two-dimensional array.

6. The apparatus as recited in claim 1 wherein said electronic light sources are light-emitting-diodes, each of said electronic light sources including a set of light emitting diodes capable of transmitting light of three different colors.

7. A method of videoconferencing, comprising:
receiving light from an object and into a camera, said light received substantially through substantially transparent regions of a flat panel display that are interspersed among electronic light sources of said flat panel display; and
producing image data from said received light, said image data being usable to reproduce a two-dimensional image of said object on a screen.

8. The method as recited in claim 7 wherein said electronic light sources form a regular two-dimensional array over a substantially transparent substrate.

9. The method as recited in claim 7 further comprising illuminating a portion of the electronic light sources to display another two-dimensional image on said flat panel display while performing the receiving.

10. The method as recited in claim 7 wherein said electronic light sources are arranged in a first regular two-dimensional array and said substantially transparent regions are arranged in a second regular two-dimensional array.

11. The method as recited in claim 10 wherein said electronic light sources of said first array are laterally interleaved with said substantially transparent regions of said second array.

12. The method as recited in claim 7 wherein each electronic light source is a set of light-emitting-diodes, said set capable of emitting light of three different colors.

13. An apparatus, comprising:
a first videoconferencing terminal connectable to support a videoconferencing session video with a second videoconferencing terminal via a telecommunications network, wherein said first terminal includes:
a flat panel display having electronic light sources fabricated over a substrate such that substantially transparent regions of the substrate are interspersed between said electronic light sources and are capable of transmitting external light through the display; and
a camera configured to receive the external light through the display via said substantially transparent regions.

14. The apparatus as recited in claim 13 wherein said camera and said electronic light sources are configured to operate in concurrent image acquisition and image display modes.

15. The apparatus as recited in claim 14 wherein said electronic light sources are arranged in a first regular two-dimensional array and said substantially transparent regions are arranged in a second regular two-dimensional array, said electronic light sources of said first regular two-dimensional array being laterally interleaved with said substantially transparent regions of said second regular two-dimensional array.

16. The apparatus as recited in claim 13 wherein each electronic light source is a set of light-emitting-diodes, each set being capable of emitting light of three colors.

17. The apparatus as recited in claim 13 wherein said first terminal further includes a microphone configured to generate an audio signal in response to receiving acoustic energy.

18. The apparatus as recited in claim 17 wherein said first terminal further include a speaker configured to generate a sound in response to receiving an audio signal.
